(19) United States
(12) Patent Application Publication
(10) Pub. No.: US 2005/0259633 A1
(43) Pub. Date: Nov. 24, 2005

(54) Communication path control program and communication path control device in computer network system

(75) Inventor: Kazushi Kato, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/948,943

(22) Filed: Sep. 24, 2004

(30) Foreign Application Priority Data
May 18, 2004 (JP) 2004-148279

(51) Int. Cl. H04L 12/28

(52) U.S. Cl. 370/351

(57) ABSTRACT

A communication control processor at a transmission side add a path control information area to a TCP data area of data acquired from an application, saves the destination address, and selects a pair of addresses of the transmission communication adapter and the reception communication adapter in consideration of the condition of the path and the number of connections to send the data. A communication control processor at the reception side stores the destination IP address stored in the path control information into the destination IP storing area, deletes the path control information area added to the TCP data area by the transmission side, and passes the data to an application when the address of the own communication adapter is set in the destination IP storing area in the received data.

### BACKGROUND OF THE INVENTION

The present invention relates to a communication path control program and a communication path control device for transmission/reception of data between computers through a computer network using TCP/IP.

When two server computers each of which equips a plurality of communication adapters (NIC) transmit/receive data through a computer network, a connection is established by specifying communication adapters, which are used by the server computers, for every application because an application does not have a function to specify a communication path. Since a plurality of applications are executed on the server computer at the same time in general, a plurality of connections are established at the same time.

Japanese unexamined patent publication Nos. H10-042380, H11-341042 and H08-032599 disclose technologies that teach a technical background of the present invention.

The publication No. H10-042380 discloses a technique to inform operating situation using UDP, the publication No. H11-341042 discloses a technique to have a logical IP address in addition to an IP address of a network adapter and to get path information with reference to a routing table, and the publication No. H08-032599 discloses a technique to inform a changeover of communication through a LAN adapter.

According to the above described conventional communication control methods, however, since the sever computer does not have a function to select communication adapters in consideration of load dispersion and risk spread, a plurality of connections may concentrate on a predetermined communication adapter with deviation. When the connections concentrate on the predetermined communication adapter in this way, throughput decreases due to increased load on the communication adapter, and a breakdown of the communication adapter shuts down the plurality of connections at the same time. That is, the conventional communication control methods cannot construct a load-dispersed network that divides connections into a plurality communication paths according to the load and a risk-spread network that divides connections to a plurality of communication paths to spread risk.

Such problems will be specifically described. FIG. 12 shows a condition where a plurality of connections are established on a single communication path with concentration according to the conventional communication path control method. The computer network system shown in FIG. 12 has two server computers land 2 that are connected to each other through a network N such as the Internet.

An application 3 is executed on one server computer 1. The server computer 1 is provided with two communication adapters a1 and a2 that are connected with the network N through a router 4. In the same manner, an application 5 is executed on the other server computer 2. The server computer 2 is provided with communication adapters b1 and b2 that are connected with the network N through a router 6.

When data is exchanged between the application 3 executed on the server computer 1 and the application 5 executed on the server computer 2 under the above-described construction, the connections C2, C2, . . . , Cn may be established on the communication path through the communication adapters a1 and b1 as indicated by the bold lines with arrows in FIG. 12, for example.

Further, according to the conventional communication control method, if a communication adapter through which a connection is established on one server computer breaks down, since the server computer on the other side of the communication cannot detect the breakdown immediately, the communication stops until the time when an alternative communication path is established.

In addition, there is loose source routing (a communication method to specify routers on a communication path in the order of data transmission) as an option of the IP. However, since some routers void this option, the IP option cannot perfectly solve the deviation of the communication paths.

### SUMMARY OF THE INVENTION

It is therefore an object of the present invention to provide communication path control program and device, which is capable of preventing concentration of connections on a single communication adapter to disperse a load and risk in a communication between server computers each of which has a plurality of communication adapters (NIC).

For the above object, according to the present invention, there is provided an improved communication path control program that controls a communication between server computers that are connected through a network using TCP/IP and each of which contains a communication control processor and a plurality of communication adapters, which includes steps of:

making the communication control processor at the transmission side add a path control information area to a TCP data area that has TCP data, a transmission address storing area and a destination address storing area;

allowing communication with specifying communication adapters for each connection by setting a communication adapter address of a server computer at the transmission side and a destination address in a path control information area based on path selecting information including a destination address, a transmission adapter address and a reception adapter address; and

making the communication control processor of the server computer at the reception side delete the path control information area from the TCP data area of received data.

Further, the communication path control program may include steps of:

making the communication control processor of the server computer at the transmission side set the destination address and a communication adapter address of the server computer at the transmission side in the path control information area and set a communication adapter address of the destination server computer in the destination address storing area;

making a communication control processor of the server computer at the reception side store the destination address stored in the path control information area into the destination address storing area and delete the path control information area.

Still further, the communication path control program may include steps of:

making the communication control processor of the server computer at the transmission side update path selecting information to prohibit from selecting the communication path through a broken communication adapter when a breakdown of a its own communication adapter is detected;

making the communication control processor of the server computer at the reception side keep the connection by replacing the managed address of the opposite communication adapter with an address of the opposite communication adapter stored in the path information control area, when the address of the opposite communication adapter managed for every connection is different from the address of the opposite communication adapter stored in the path control information area in the TCP data area of the received data.

Yet further, in addition to the above breakdown detecting function or in place of it, the following function may be provided. That is, when a breakdown of a communication adapter of the own server computer, the program makes the communication control processor of the server computer that detected a breakdown send breakdown information to the opposite server computer by UDP aside from normal transmission data. On the other side, the program makes the communication control processor of the opposite server computer update the path selecting information so that it cannot select the communication path through the communication adapter from which the breakdown was detected when the communication control processor receives the breakdown information.

The communication path control device in a computer network system of the present invention includes:

a communication control processor of the server computer at the transmission side that adds a path control information area to a TCP data area that has TCP data, a transmission address storing area and a destination address storing area and that allows communication with specifying communication adapter for each connection by setting a communication adapter address of a server computer at the transmission side and the destination address in the path control information area based on a path selecting information including a destination address, a transmission adapter address and a reception adapter address; and

a communication control processor of the server computer at the reception side that deletes the path control information area from the TCP data area of received data.

According to the communication path control program of the present invention constructed as above, since the communication control processor of the server computer at the transmission side can establish a connection with specifying addresses of the transmission and reception communication adapters based on the path selecting information, the connections can be dispersed among communication paths between communication adapters according to the use patterns of communication adapters and/or load of the other connections. Therefore, a load-dispersed network and a risk-spread network can be constructed.

In addition, since the address of the communication adapter is stored in the TCP data area in TCP/IP, the program is effective to a router that voids the lose routing option in the IP.

Further, since the detection of a breakdown affects the path selecting information, the opposite server computer can check the information against the own managed information. When the check result seems mismatch, the server computer determines that the adapter is broken and changes the communication path through the other communication adapters.

Further, when the breakdown information is sent by the UDP aside from the normal transmission data, the server computer can detect a breakdown of the communication adapter of the opposite server computer without exchanging data, which allows selecting an active communication path without a breakdown before exchanging data. Therefore, if any of communication adapters was broken, the opposite server computer can immediately change the communication path and can keep the connection.

### DESCRIPTION OF THE ACCOMPANYING DRAWINGS

FIG. 1 is a block diagram of a computer network system on which communication paths are established by a communication path control method of an embodiment;

FIG. 2 shows a construction of path selecting information according to the communication path control method of the embodiment;

FIG. 3 is a table showing path selecting information managed by a communication control processor in a gateway A of FIG. 1;

FIG. 4 is a table showing path selecting information managed by a communication control processor in a gateway B of FIG. 1;

FIG. 5 is a flowchart showing process contents of the data transmitting server according to the communication path control method of the embodiment;

FIG. 6 shows an example of exchanging data according to the communication path control method of the embodiment;

FIG. 7 is a flowchart showing process contents of the server computer at the data reception side according to the communication path control method of the embodiment;

FIG. 8 shows an example of exchanging data according to the communication path control method of the embodiment;

FIG. 9 is a block diagram of the computer network system showing a condition where the communication path is changed by the communication path control method of the embodiment;

FIG. 10 is a flowchart showing process contents of a breakdown detection process in the communication path control method of the embodiment;

FIG. 11 is a flowchart showing process contents of a breakdown informing process in the communication path control method of the embodiment; and

FIG. 12 is a block diagram of a computer network system on which communication paths are established by a conventional communication path control method.

### DESCRIPTION OF THE PREFERRED EMBODIMENTS

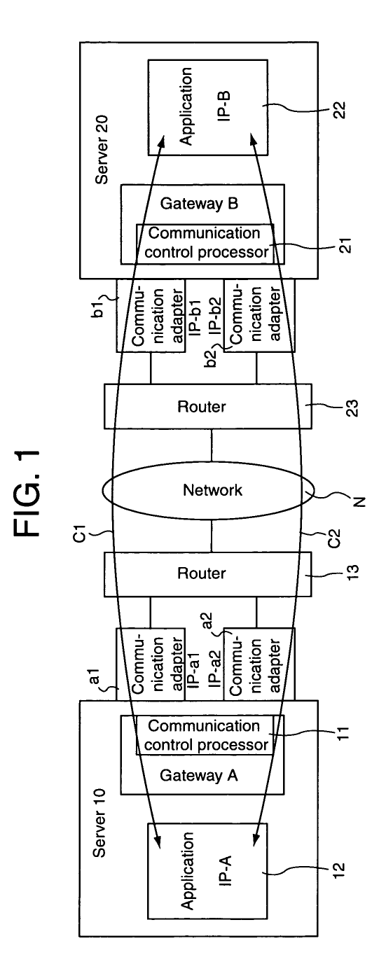

Hereinafter, communication path control program and device in a computer network system according to an embodiment of the present invention will be described with reference to the drawings. The communication path control program of the embodiment is employed to control communication paths among a plurality of server computers (referred to as servers in the following description) that are connected through a network. FIG. 1 shows one example of the computer network system in which two servers 10 and 20 are connected through a network N such as the Internet.

One server 10 has a gateway A in which a communication control processor 11 is installed. An application 12 is executed on the server 10. The server 10 has two communication adapters a1 and a2 that are connected to the network N through a router 13.

In the same manner, the other server 20 has a gateway B in which a communication control processor 21 is installed. An application 22 is executed on the server 20. The server 20 has two communication adapters b1 and b2 that are connected to the network N through a router 23.

Assume that an IP address of the server 10 (the IP address viewed from the application 22 on the server 20) is IP-A and IP addresses of the communication adapters a1 and a2 are IP-a1 and IP-a2, respectively. Further, assume that an IP address of the server 20 (the IP address viewed from the application 12 on the server 10) is IP-B and IP addresses of the communication adapters b1 and b2 are IP-b1 and IP-b2, respectively.

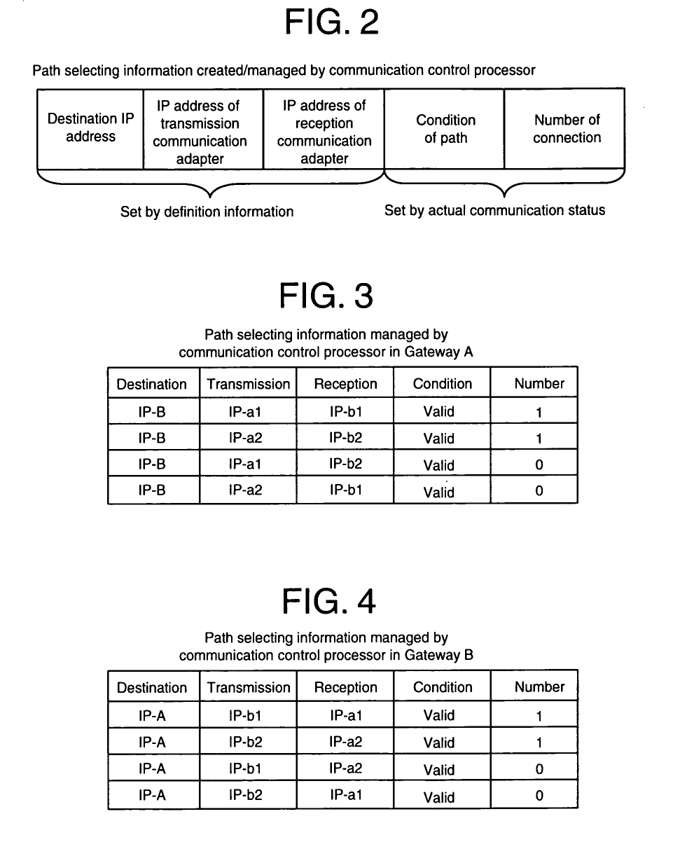

The respective communication control processors 11 and 12 create and manage path selecting information whose formats are shown in FIG. 2. The path selecting information is a table having a plurality of records each of which includes five fields. One record is created for one connection that can be established.

As shown in FIG. 2, there area “destination IP address” field that stores an address of the opposite side to which the server in question sends data, an “IP address of transmission communication adapter” field that stores an address of the communication adapter connected to the server in question and used for a connection with the opposite side, an “IP address of reception communication adapter” field that stores an address of the communication adapter used for a connection in the opposite server at the reception side, a “path condition” field that stores a condition whether the communication path is useful to establish a connection or not (i.e., whether the path is valid or invalid), and the “number of connections” field that stores the number of connections established on the communication path. The former three fields are set in advance based on definition information defined in the servers 10 and 20. The later two fields are set in response to the actual communication status.

On the basis of the computer network system in FIG. 1, path selecting information managed by the communication control processor 11 in the gateway A includes four records shown in FIG. 3. In the same manner, path selecting information managed by the communication control processor 21 in the gateway B includes four records shown in FIG. 4. In FIG. 3 and FIG. 4, the field names “destination IP address”, “IP address of transmission communication adapter”, “IP address of reception communication adapter”, “path condition” and “number of connections” are abbreviated to “destination”, “transmission”, “reception”, “condition” and “number”, respectively. Further, the example shown in FIG. 3 and FIG. 4 is premised that all the communication adapters function normally, and shows the condition where the exchange connection C1 through the communication adapters a1, b1 and the exchange connection C2 through the communication adapters a2, b2 are established as shown by solid lines in FIG. 1.

The communication control processors 11 and 21 of the servers 10 and 20 distribute the connections among different communication paths using the above-described path selecting information, which enables load dispersion and risk spread. That is, the communication control processors 11 and 21 provide functions to intercept the TCP/IP control as described below, which enables transmission/reception between the communication adapters (a pair of a transmission communication adapter and a reception communication adapter) specified for each connection.

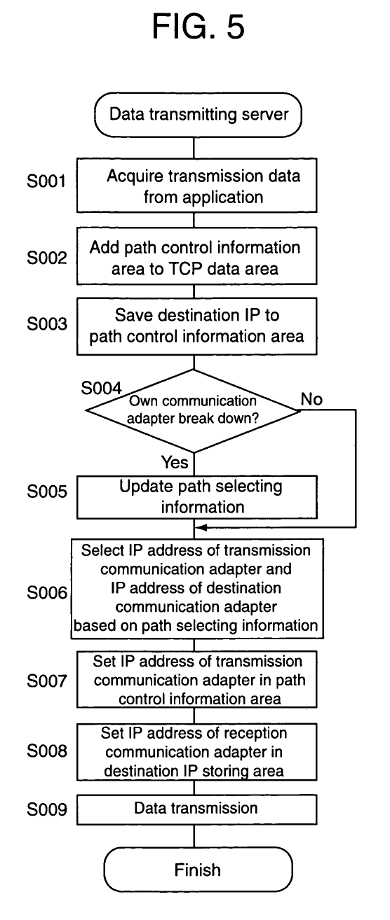

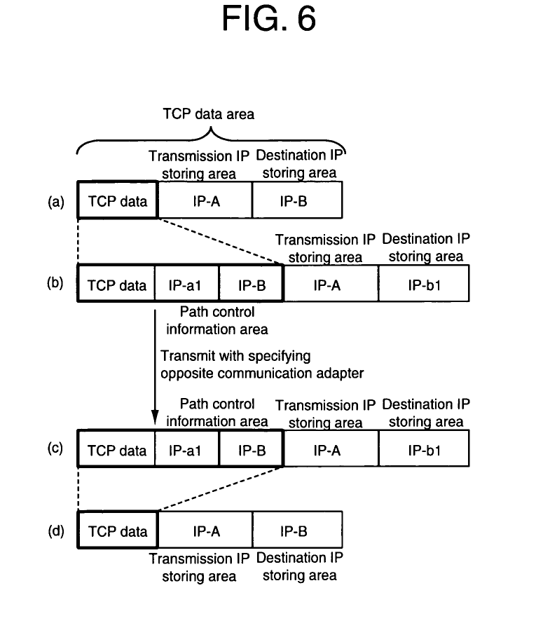

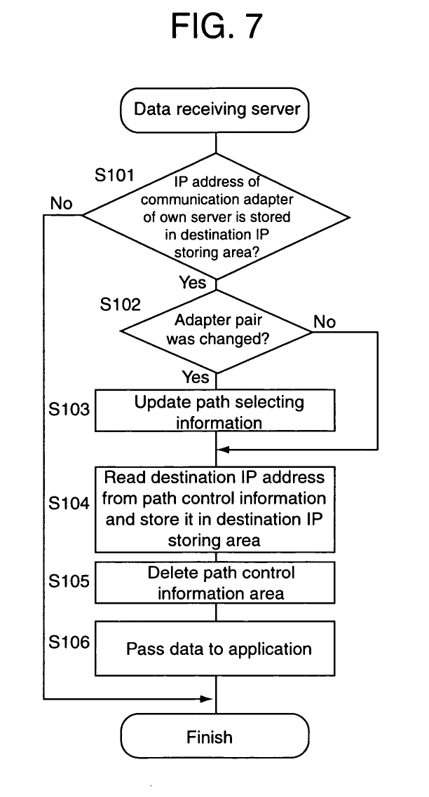

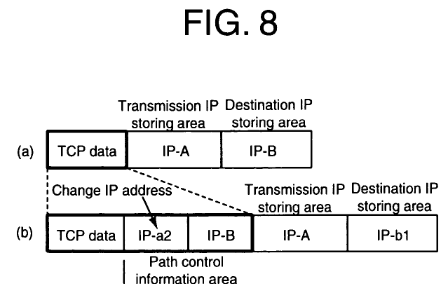

Hereinafter, the functions of the communication control processors 11 and 12 during data exchanging will be described with separating the functions into the transmission side and the reception side with reference to flowcharts in FIGS. 5 and 7 and data constructions shown in FIGS. 6 and 8. The following description premised that data transmitted from the application 12 of the server 10 is received by the application 22 of the server 20.

At the time of data transmission, as shown in the flowchart in FIG. 5, the communication control processor 11 in the gateway A at the transmission side acquires transmitting data (FIG. 6(a)) from the application 12 (S001) and adds the path control information area to the TCP data area (S002). The TCP packet contains, as shown in FIG. 6(a), a TCP data area that has TCP data, a transmission IP storing area, and a destination IP storing area. The address “IP-A” of the server 10, which is the transmission IP, is stored in the transmission IP storing area. The address “IP-B” of the server 20, which is the destination IP, is stored in the destination IP storing area. In a process at S002, the TCP data area is enlarged to add the path control information area.

Next, the communication control processor 11 saves the “IP-B” that is the destination IP to the path control information area (S003). Then, the communication control processor 11 determines whether the own communication adapters 1a and a2 break down or not (S004). If any of the adapters is broken, the process updates the path selecting information shown in FIG. 3 to prohibit from selecting the communication path through a broken communication adapter (S005). Specifically, “invalid” is set in the “condition” field of the record corresponding to the broken communication adapter.

Next, the communication control processor 11 selects a pair of the IP address of the transmission communication adapter and the IP address of the destination communication adapter based on the path selecting information (S006). That is, the communication control processor 11 selects the communication path whose “condition” is “valid” and “number” is minimum in the table of FIG. 3. Then, the communication control processor 11 sets the IP address of the transmission communication adapter in the path control information area added to the TCP data area based on the selected communication path (S007), and sets the IP address of the reception communication adapter in the destination IP storing area (S008). In the example of FIG. 6, “IP-a1” is set as the IP address of the transmission communication adapter and “IP-b1” is set as the IP address of the reception communication adapter as shown in FIG. 6(b).

Finally, the communication control processor 11 transmits the data in which the path information is stored in the TCP data area as described-above (S009). As a result, the communication path through the communication adapters a1 and b1 (C1 in FIG. 1) is designated, and data (packet) is transmitted through the path for the server 20.

On the other hand, at the time of receiving data, the communication control processor 21 in the gateway B at the reception side judges, as shown in a flowchart of FIG. 7, whether the IP address of the own communication adapter (IP-b1 or IP-b2) is stored in the destination IP storing area of the received data or not (S101). If the IP address of the own communication adapter is not stored, the communication control processor 21 finishes the process immediately. The data construction at the time of reception is shown in FIG. 6(c).

If the IP address of the own communication adapter is stored, the communication control processor 21 determines whether the information of the communication adapter pair was changed or not (S102). If the communication adapter pair was changed, the communication control processor 21 updates the path selecting information (S103). The communication control processors 11 and 21 manage the communication adapter pair, which is used for communication, for each connection. When the information about communication adapter pair is changed (i.e., when the managed IP address of the opposite communication adapter is different from the IP address of the opposite communication adapter stored in the path control information area in the TCP data area of the received data), the communication control processor (11 or 21) replaces the managed IP address of the opposite communication adapter with the IP address of the opposite communication adapter stored in the path control information area (changes the path to a different path defined in path selecting information) to keep communication.

Next, the communication control processor 21 stores the destination IP address “IP-B” stored in the path control information area in the TCP data area into the destination IP storing area (S104). Then, the communication control processor 21 deletes the path control information area added to the TCP data area at the transmission side (S105), and passes the data to the application 22 (returns to TCP/IP control, S106). The data construction passed to the application 22 is shown in FIG. 6(d) that is identical to the construction of the data acquired from the application 12 of the server at S001 in FIG. 5.

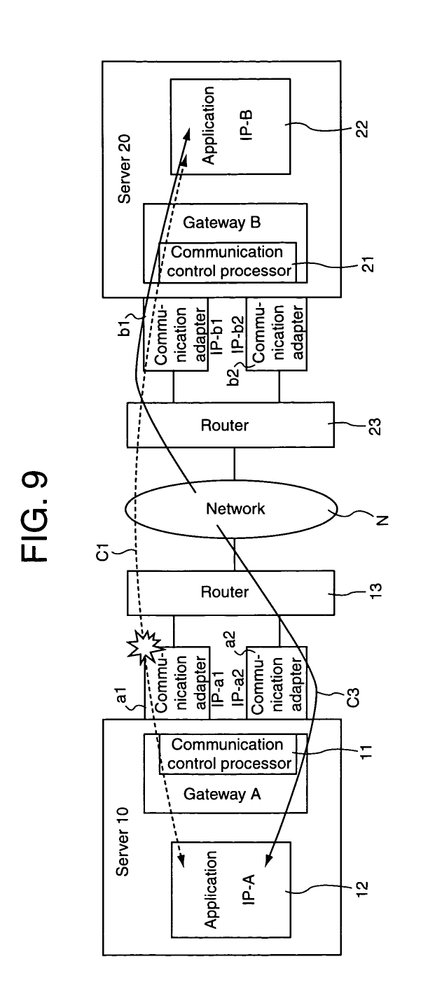

The data construction in FIG. 6 is an example when the communication adapters a1 and b1 located on the selected path are not broken. An example when a breakdown of the communication adapter al is detected at S004 in FIG. 5 will be described with reference to FIGS. 8 and 9.

When the breakdown of the communication adapter al is detected, the communication control processor 11 sets “invalid” in the “condition” field of the record whose path includes the communication adapter al that is extracted from the records of the path selecting information. Therefore, the communication control processor 11 cannot select the path C1 in FIG. 1 at S006. In this embodiment, since the server 10 is provided with two communication adapters, the communication control processor 11 can select the path going through the other communication adapter a2.

Contents of the data passed by the application is, as shown in FIG. 8(a), the same as the above example without a breakdown, while contents of the data after setting the path control information is, as shown in FIG. 8(b), the IP address of the transmission communication adapter is changed to “IP-a2”.

When the packet is transmitted with the above contents and is received at the side of the server 20 (see FIG. 8(c)), the communication control processor 21 of the server 20 determines that the communication adapter pair was changed at S102 in FIG. 7. Once a connection is established between the specific applications, the same communication path is kept (the communication path does not change for each packet) unless a trouble occurs on the communication path. Therefore, when the communication adapter pair was changed, the communication control processor 21 determines that the communication adapter that was used just before the change (a1, in this example) was broken and sets “invalid” in the “condition” field of the records whose “reception” field contain “IP-a1” in the path selecting information shown in FIG. 4. As a result, when the server 20 transmits data to the server 10, the communication path can be selected with avoiding a broken communication adapter. In addition, since the path control information is deleted at S105, the contents of the data shown in FIG. 8(d) passed to the application are identical to the contents of the data without a breakdown even if the paths are different.

FIG. 9 shows a change of the path when the communication adapter a1 is broken down. The previous path C1 is indicated by a dotted line, and the new path C3 set after the detection of the breakdown is indicated by a solid line.

Further, the server of the embodiment has a function to inform a breakdown of the communication adapter to the opposite server when it is detected without respect to data exchange in addition to the above-described breakdown detection function.

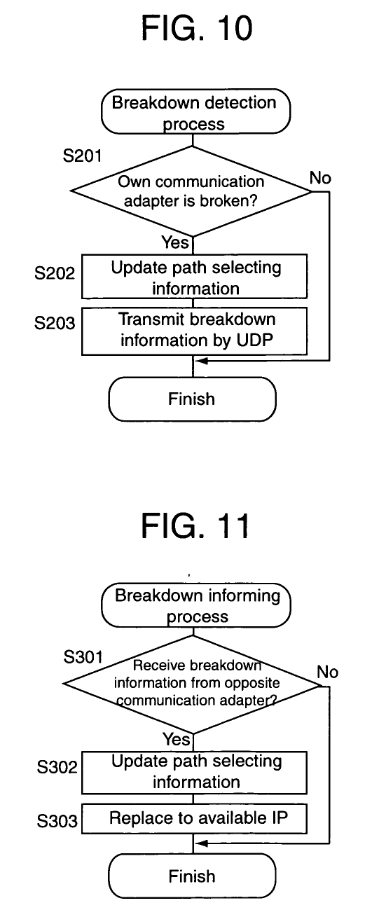

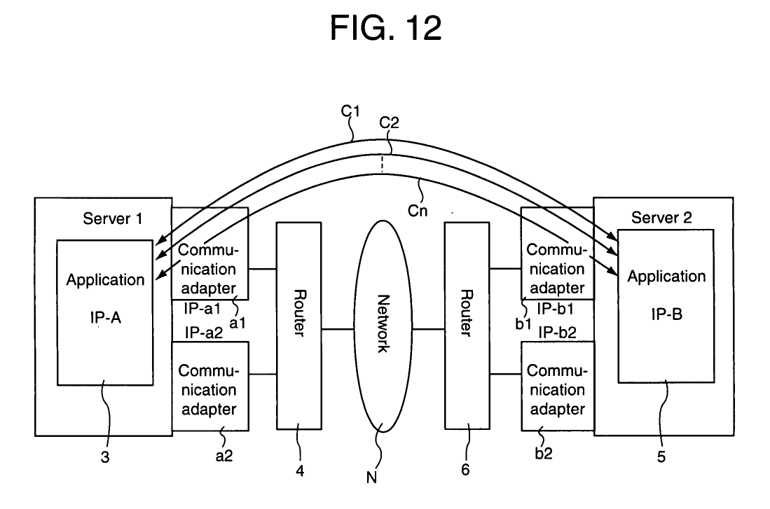

This function is shown in flowcharts in FIGS. 10 and 11. The communication control processors 11 and 21 of the respective servers inspect a breakdown of the own communication adapters by a conventional method at a predetermined time intervals. As shown in FIG. 10, at the breakdown detection side, the server determines whether a breakdown of own communication adapter was detected or not (S201). Detecting a breakdown, the server updates the own path selecting information in the same manner as above (S202), transmits breakdown information to the opposite server by UDP aside from normal transmission data (S202).

The opposite server that confirms the breakdown information determines whether the breakdown information of the opposite communication adapter was received or not (S301). If received, the opposite server updates the path selecting information in the same manner as above to prohibit from selecting the communication path through the broken communication adapter (S302) and replaces the IP address of the broken communication adapter to an IP address of an available communication adapter (S303) when the connection is established through the broken communication adapter.

Providing the function shown in FIGS. 10 and 11, a server can inform information about a breakdown of a communication adapter to the opposite server regardless of the presence or absence of the data exchange. As a result, if a communication adapter breaks down, the next effective connection can be established immediately.

1. A communication path control program in a computer network system that controls communication between server computers that are connected through a network using TCP/IP and each of which contains a communication control processor and a plurality of communication adapters, said program comprising:
making the communication control processor at the transmission side add a path control information area to a TCP data area that has TCP data, a transmission address storing area and a destination address storing area;
allowing communication with specifying communication adapters for each connection by setting a communication adapter address of a server computer at the transmission side and a destination address in a path control information area based on path selecting information including a destination address, a transmission adapter address and a reception adapter address; and
making the communication control processor of the server computer at the reception side delete the path control information area from the TCP data area of received data.

2. The communication path control program according to claim 1, further comprising:
making the communication control processor of the server computer at the transmission side set the destination address and a communication adapter address of the server computer at the transmission side in the path control information area and set a communication adapter address of the destination server computer in the destination address storing area;
making a communication control processor of the server computer at the reception side store the destination address stored in the path control information area into the destination address storing area and delete the path control information area.

3. The communication path control program according to claim 1 or 2, further comprising:
making the communication control processor of the server computer at the transmission side update path selecting information to prohibit from selecting the communication path through a broken communication adapter when a breakdown of a its own communication adapter is detected;
making the communication control processor of the server computer at the reception side keep the connection by replacing the managed address of the opposite communication adapter with an address of the opposite communication adapter stored in the path information control area, when the address of the opposite communication adapter managed for every connection is different from the address of the opposite communication adapter stored in the path control information area in the TCP data area of the received data.

4. The communication path control program according to one of claims 1 through 3, further comprising:
making the communication control processor of the server computer that detected a breakdown send a breakdown information to the opposite server computer by UDP aside from normal transmission data when a breakdown of a communication adapter of the own server computer; and
making the communication control processor of the opposite server computer update the path selecting information so that it cannot select the communication path through the communication adapter from which the breakdown was detected when the communication control processor receives the breakdown information.

5. A communication path control device in a computer network system that controls communication between server computers that are connected through a network using TCP/IP and each of which contains a communication control processor and a plurality of communication adapters, said device comprising:
a communication control processor of the server computer at the transmission side that adds a path control information area to a TCP data area that has TCP data, a transmission address storing area and a destination address storing area, and allows communication with specifying communication adapters for each connection by setting a communication adapter address of a server computer at the transmission side and a destination address in a path control information area based on path selecting information including a destination address, a transmission adapter address and a reception adapter address; and
a communication control processor of the server computer at the reception side that deletes said path control information area from the TCP data area of received data.

6. A communication path control method in a computer network system that controls communication between server computers that are connected through a network using TCP/IP and each of which contains a communication control processor and a plurality of communication adapters, said method comprising:
a communication control processor of the server computer at the transmission side adds a path control information area to a TCP data area that has TCP data, a transmission address storing area and a destination address storing area, and allows communication with specifying communication adapters for each connection by setting a communication adapter address of a server computer at the transmission side and a destination address in a path control information area based on path selecting information including a destination address, a transmission adapter address and a reception adapter address; and
a communication control processor of the server computer at the reception side deletes said path control information area from the TCP data area of received data.
